(19) United States
(12) Patent Application Publication
(10) Pub. No.: US 2009/0004488 A1
(43) Pub. Date: Jan. 1, 2009

(54) Resine Composition For Printed Circuit Board and Composite Substrate And Copper Laminates Using The Same

(75) Inventors: Kwang Suk PARK, Yongin-si (KR); In Wook Kim, Seoul (KR); Duk Sang Han, Daejeon (KR); Soo Im Jung, Yongin-si (KR); Dong Ki Nam, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Doosan Corporation, Seoul (KR)

(21) Appl. No.: 12/146,643

(22) Filed: Jun. 26, 2008

(30) Foreign Application Priority Data
Jun. 26, 2007 (KR) 10-2007-0063164
Jun. 26, 2007 (KR) 10-2007-0063166

(51) Int. Cl. B32B 15/08; C08K 5/05

(52) U.S. Cl. 428/458; 524/540; 524/508; 524/81; 524/395

(57) ABSTRACT

Disclosed is a resin composition for a PCB, the composition including: (a) a polyphenylene ether resin modified via a redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide; (b) a polymer binder; and (c) cyanate ester or a prepolymer of the cyanate ester, wherein, when the polyphenylene ether resin is modified via a redistribution reaction of the polyphenylene ether in the presence of 9,9-bis(hydroxyaryl)fluorene, the composition further includes (d) a flame retardant. Also, a composite substrate and a copper laminate using the same are disclosed.

This is a non-provisional which claims priority from Korean Patent Application 10-2007-0063164 filed on Jun. 26, 2007, and Korean Patent Application Korean Patent Application 10-2007-0063166 filed Jun. 26, 2007, all of which are incorporated herein by reference.

### BACKGROUND OF THE INVENTION

(a) Field of the Invention

The present invention relates to a resin composition for fabricating a printed circuit board having an excellent dielectric property, and a composite substrate and a copper laminate using the same.

(b) Description of the Related Art

As a printed circuit board (hereinafter, referred to as ‘PCB’), a laminate fabricated by layering a predetermined number of prepregs and subjecting the prepregs to a heat/pressure forming treatment has been conventionally used, each of the prepregs being obtained by impregnating a substrate, such as glass fabric, with an epoxy resin or polyimide, followed by drying. However, recently, as an electronic device has been miniaturized and has had high performance, a PCB has rapidly become highly dense and multi-layer structured. Accordingly, as an insulating substrate for such a PCB, a copper laminate fabricated by layering a predetermined number of prepregs and subjecting the prepregs to a heat/pressure forming treatment has been used, each of the prepregs being obtained by impregnating a substrate, such as glass fabric, with an epoxy resin or polyimide, followed by drying.

Meanwhile, in a recent electronic information device, such as a computer, an operating frequency increases by short-time treatment of a large amount of information, thereby increasing a transmission loss and a signal delay time. Accordingly, in order to solve such a problem, a copper laminate having characteristics, such as low permittivity and a low dielectric tangent (tan δ), has been required. In general, since a signal delay time in a PCB increases in proportion to the square root of relative permittivity (εr) of an insulating material in the vicinity of wiring, a resin composition having low permittivity is required for a board requiring a high transmission speed. However, a currently conventionally used copper laminate with FR-4 grade has relatively high permittivity of about 4.5 to 5.5, and thus there is a problem of an increase in transmission loss and signal delay time.

It is known that as a conventional resin composition for coping with such high frequency of a signal and improving the high frequency characteristics of a PCB, a combination of cyanate ester (which is a thermosetting resin having very low permittivity) and an epoxy resin has been used. Also, a method of using a thermoplastic resin, such as a fluororesin or a polyphenylene ether resin, etc., has been known.

However, in this technology, an epoxy resin used as a base material is insufficient to meet the high frequency characteristics due to its high permittivity. In addition, the increase of the ratio of a cyanate ester resin or a thermoplastic resin used for decreasing permittivity may cause a serious problem in that in the process of fabricating a PCB, the workability or processibility is largely reduced. Especially, in using a polyphenylene ether resin which is a thermoplastic resin, there is a problem in that the melt viscosity of a resin composition is increased, and the flowability is largely reduced. Accordingly, it is very difficult to fabricate a laminate through press molding by high temperature and high pressure, or to fabricate a multilayer printed wiring board in which grooves between micro circuit patterns are required to be filled up. Also, there is a problem in that adhesive strength with a copper foil and heat resistance are significantly reduced.

Meanwhile, a resin composition where an epoxy resin is combined with a phenol added butadiene polymer has been conventionally used to fabricate a laminate of which a dielectric property, heat resistance and moisture resistance are improved. However, due to high molecular weight of the phenol added butadiene polymer, in fabricating a prepreg by impregnating and drying a sheet type substrate with the resin composition, a large amount of bubbles may occur on the surface of the prepreg. As a result, voids may occur within the formed laminate, and thus the laminate may be inappropriate for use as an insulating substrate of a PCB.

Also, it has been reported that since the permittivity of E-glass used as a substrate for a conventional copper laminate with FR-4 grade is very high, a material having low permittivity, such as synthetic polyamide fiber, D-glass, or quartz has been used as a substrate. In such a case, in drilling a PCB, a drill may be significantly worn away, and particularly there is a problem in that fabrication cost for the PCB is increased.

### SUMMARY OF THE INVENTION

Therefore, the present invention has been made in view of the above-mentioned problems. The present invention provides a resin composition for a PCB, which has desirable formability and processibility, thereby preventing the occurrence of voids (caused by foaming) on a prepreg surface within a laminate and significantly improving physical properties, such as dielectric property, heat resistance, adhesive strength, etc.

Also, the present invention provides a composite substrate and a copper laminate using the resin composition.

In accordance with an aspect of the present invention, there is provided a resin composition for a PCB, the composition including: (a) a polyphenylene ether resin modified via a redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide; (b) a polymer binder; and (c) cyanate ester or a prepolymer of the cyanate ester, wherein, when the polyphenylene ether resin is modified via a redistribution reaction of the polyphenylene ether in the presence of 9,9-bis(hydroxyaryl)fluorene, the composition further includes (d) a flame retardant.

In accordance with another aspect of the present invention, there is provided a composite substrate formed by coating or impregnating a substrate with a resin composition for a PCB, followed by drying, the resin composition for the PCB including: (a) a polyphenylene ether resin modified via a redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide; (b) a polymer binder; and (c) cyanate ester or a prepolymer of the cyanate ester, wherein, when the polyphenylene ether resin is modified via a redistribution reaction of polyphenylene ether in the presence of 9,9-bis(hydroxyaryl)fluorene, the composition further includes (d) a flame retardant

Also, the present invention provides a copper laminate formed by laminating the composite substrate and a copper foil, followed by heat/pressure forming.

### DETAILED DESCRIPTION OF THE INVENTION

Hereinafter, the present invention will be described in detail.

A resin composition for a printed circuit board (PCB) of the present invention includes a polyphenylene ether resin modified via a redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide. Specifically, the resin composition for the printed circuit board (PCB) includes a polyphenylene ether resin modified to have a low molecular weight via a redistribution reaction of polyphenylene ether having high molecular weight with 9,9-bis(hydroxyaryl)fluorene or 9,10-dihydro-9-oxa-10-(dihydroxyaryl)-10-phosphaphenanthrene 10-oxide.

Conventionally, in modifying high molecular weight polyphenylene ether into a low molecular weight polyphenylene ether resin, a compound, such as a phenol derivative or bisphenol A, has been usually used. In this case, rotation in a molecular structure may occur, thereby reducing permittivity.

However, in the present invention, instead of a conventionally used compound such as a phenol derivative or bisphenol A, 9,9-bis(hydroxyaryl)fluorene or 9,10-dihydro-9-oxa-10-(dihydroxyaryl)-10-phosphaphenanthrene 10-oxide is used to modify high molecular weight polyphenylene ether into a low molecular weight polyphenylene ether resin, thereby preventing rotation in a molecular structure while introducing many hydrophobic bicyclic hydrocarbon groups. Accordingly, it is possible to reduce occurrence of electronic polarization, thereby decreasing permittivity. Also, compared to the conventionally used phenol derivative or bisphenol A, 9,9-bis(hydroxyaryl)fluorene and 9,10-dihydro-9-oxa-10-(dihydroxyaryl)-10-phosphaphenanthrene 10-oxide has a bulky molecular structure and high crystallinity. Thus, a polyphenylene ether resin modified to have a low molecular weight may have a high glass transition temperature. Also, through improvement of a dielectric property, a PCB of low permittivity and low loss may be achieved, and the increase of hydrophobic groups may increase moisture absorption. Also, a cross-linking property may be improved, thereby improving heat resistance and chemical resistance.

Therefore, a composite substrate and a copper laminate, which are fabricated by using a resin composition of the present invention, have an advantage in that the physical properties, such as formability, processibility, dielectric property, heat resistance, adhesive strength, etc., are improved.

Also, since 9,10-dihydro-9-oxa-10-(dihydroxyaryl)-10-phosphaphenanthrene 10-oxide is self-extinguishing due to phosphorous included in the molecules, a polyphenylene ether resin modified by using the material may be flame retardant. Therefore, even though the resin composition of the present invention does not include an additional flame retardant material, a composite substrate and a copper laminate fabricated by using the same may have high flame retardancy.

A resin composition for a PCB of the present invention may include 10 to 60 parts by weight of polyphenylene ether, 0.1 to 5 parts by weight of 9,9-bis(hydroxyaryl)fluorene or 9,10-dihydro-9-oxa-10-(dihydroxyaryl)-10-phosphaphenanthrene 10-oxide, 5 to 40 parts by weight of a polymer binder, and 10 to 60 parts by weight of cyanate ester or a prepolymer of the cyanate ester. Also, in the case when a flame retardant is further included, the flame retardant may be used in an amount of 5 to 40 parts by weight.

In the present invention, the polyphenylene ether to be modified may be high molecular weight polyphenylene ether, and have a number-average molecular weight of 1,000 to 30,000. Also, there is no particular limitation in the polyphenylene ether, as long as the polyphenylene ether is used as a main skeleton.

Also, the 9,9-bis(hydroxyaryl)fluorene may be at least one compound selected from the group including compounds represented by following Formula 1 to Formula 3.

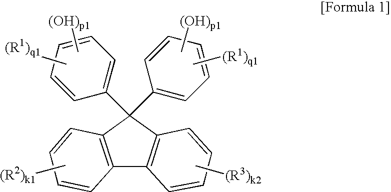

In Formula 1, each of R¹ to R³ independently represents a C₁˜C₆ alkyl group, p1 is an integer ranging from 1 to 5, q1 is an integer ranging from 0 to 4, p1+q1 is an integer equal to or less than 5, and each of k1 and k2 is independently an integer ranging from 0 to 4.

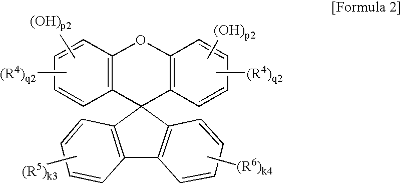

In Formula 2, each of R⁴ to R⁶ independently represents a C₁˜C₆ alkyl group, p2 is an integer ranging from 1 to 4, q2 is an integer ranging from 0 to 3, p2+q2 is an integer equal to or less than 4, and each of k3 and k4 is independently an integer ranging from 0 to 4.

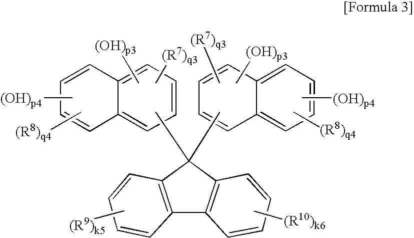

In Formula 3, each of R⁷ to R¹⁰ independently represents a C₁˜C₆ alkyl group, p3 is an integer ranging from 1 to 3, p4 is an integer ranging from 0 to 4, each of q3 and q4 is independently an integer ranging from 0 to 2, p3+q3 is an integer equal to or less than 3, p4+q4 is an integer equal to or less than 4, and each of k5 and k6 is independently an integer ranging from 0 to 4.

Also, the 9,10-dihydro-9-oxa-10-(dihydroxyaryl)-10-phosphaphenanthrene 10-oxide may be at least one compound selected from the group including compounds represented by following Formula 4 and Formula 5.

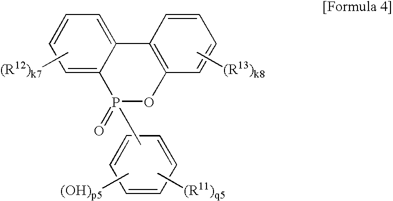

In Formula 4, each of R¹¹ to R¹³ independently represents a C₁˜C₆ alkyl group, p5 is 2, q5 is an integer ranging from 0 to 3, and each of k7 and k8 is independently an integer ranging from 0 to 4.

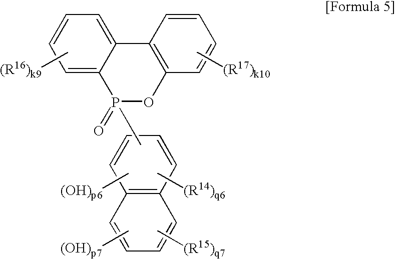

In Formula 5, each of R¹⁴ to R¹⁷ independently represents a C₁˜C₆ alkyl group, each of p6 and p7 is independently an integer ranging from 0 to 2, p6+p7 is 2, p6+q6 is an integer equal to or less than 3, p7+q7 is an integer equal to or less than 4, and each of k9 and k10 is independently an integer ranging from 0 to 4.

Also, (a) the redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide may be carried out in the presence of a radical initiator and/or a catalyst.

The radical initiator and the catalyst may include a conventional material known in the art. Examples of the radical initiator may include, but are not limited to, t-butylperoxy isopropylmonocarbonate, t-butylperoxy 2-ethylhexylcarbonate, benzoyl peroxide, acetyl peroxide, di-t-butyl peroxide, t-butyl peroxylaurate, t-butylperoxybenzoate, etc. The radical initiator may be used in an amount of 0.1 to 5 parts by weight, based on 10 to 60 parts by weight of polyphenylene ether.

Also, non-limiting examples of the catalyst include cobalt naphthanate. The catalyst may be used in an amount of 0.001 to 0.5 parts by weight, based on 10 to 60 parts by weight of polyphenylene ether.

A method of synthesizing a polyphenylene ether resin modified by a redistribution reaction of polyphenylene ether is not particularly limited, and a conventional method known in the art may be applied thereto. For example, a modified polyphenylene ether resin may be obtained by mixing polyphenylene ether with 9,9-bis(hydroxyaryl)fluorene or 9,10-dihydro-9-oxa-10-(dihydroxyaryl)-10-phosphaphenanthrene 10-oxide, and a radical initiator in the presence of a solvent or without a solvent, and heating the mixture. Herein, as the solvent, a hydrocarbon-based solvent, such as benzene, toluene, etc., may be used, but the present invention is not limited thereto. Also, the reaction temperature and reaction time may be appropriately adjusted according to number-average molecular weight of a polyphenylene ether resin to obtain through the reaction. For examples, the reaction may be carried out within a range of 60 to 200° C. for 10 minutes to 10 hours, but the present invention is not limited thereto.

In the present invention, as (b) the polymer binder, a conventional material known in the art may be used with no particular limitation. Non-limiting examples of the polymer binder may include polyvinyl acetate, phenoxy resin, a styrene-butadiene block copolymer, a poly(styrene-butadiene-methyl methacrylate) block copolymer, and poly (methyl methacrylate-butyl acrylate-methyl methacrylate)block copolymer, etc. The polymer binders may be used alone or in combination.

Also, the polymer binder may be included in an amount of 5 to 40 parts by weight, based on 10 to 60 parts by weight of polyphenylene ether. If the polymer binder is included in a very small amount, adhesive strength of an obtained copper laminate may be reduced. On the other hand, if the polymer binder is included in an excessive amount, the surface hardness may be too increased.

In the present invention, (c) the cyanate ester may have at least two cyanate groups in the molecule. When there are at least two cyanate groups in the molecule, it is possible to cure through cross-linking.

Also, (c) the cyanate ester may be at least one compound selected from the group including compounds represented by following Formula 6 and Formula 7.

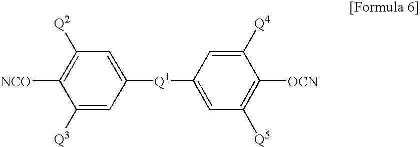

In Formula 6, Q¹ represents

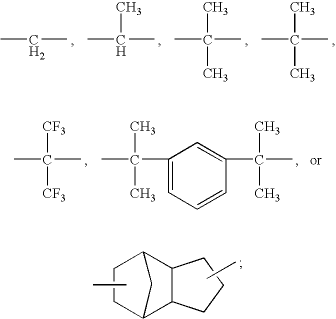

and each of Q² to Q⁵ independently represents hydrogen or a C₁˜C₆ alkyl group.

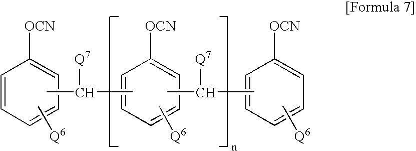

In Formula 7, each of Q⁶ and Q⁷ independently represents hydrogen or a C₁˜C₆ alkyl group, and n is an integer equal to or more than 0.

In the present invention, (c) the prepolymer of the cyanate ester is not particularly limited. Herein, the prepolymer indicates a cyanate ester oligomer, or a cyanate ester polymer, in which cyanate ester compounds form a triazine ring through cyclization.

In the prepolymer, the conversion rate of a cyanate group is not particularly limited, but is usually within a range of 10 to 70 mol %, preferably of 30 to 60 mol %. If the conversion rate is too low, varnish prepared by cyanate ester may be recrystallized due to its high crystallizing property. On the other hand, if the conversion rate is too high, the prepared varnish may have too high a viscosity, and thus it is difficult to impregnate a substrate, etc., with the varnish. In addition, the storage stability of the varnish may be reduced.

Also, non-limiting examples of the (c) cyanate ester or the prepolymer of the cyanate ester include 2,2-bis(4-cyanatephenyl)propane, bis(4-cyanatephenyl)ethane, bis(3,5-dimethyl-4-cyanatephenyl)methane, 2,2-bis(4-cyanatephenyl)-1,1,1,3,3,3-hexafluoropropane, α,α′-bis(4-cyanatephenyl)-m-diisopropylbenzene, cyanate ester of a phenol added dicyclopentadiene polymer, phenol novolak type cyanate ester, cresol novolak type cyanate ester, and a prepolymer thereof. The cyanate esters or prepolymers may be used alone or in combination.

The cyanate ester or the prepolymer of the cyanate ester may be included in an amount of 10 to 60 parts by weight, based on 10 to 60 parts by weight of polyphenylene ether. If the content is too low, the moisture absorption property of an obtained copper laminate may be decreased, and if the content is too high, heat resistance may be decreased.

In the present invention, (d) the flame retardant is not particularly limited, but is preferably a brominated organic compound having no reactivity with a cyanate group.

The flame retardant may be at least one selected from the group including 1,2-dibromo-4-(1,2-dibromoethyl)cyclohexane, tetrabromocyclohexane, tetrabromocyclooctane, hexabromocyclodecane, hexabromocyclododecane, 2,4,6-tris(tribromophenoxy)-1,3,5-triazine, bis(tribromophenoxy)ethane, brominated polyphenylene ether and brominated polystyrene. However, the present invention is not limited thereto.

The flame retardant may be included in an amount of 5 to 40 parts by weight, based on 10 to 60 parts by weight of polyphenylene ether. When the content is within the above range, a resin composition may have sufficient heat resistance, and a cured resin may have a desirable heat resistance.

The resin composition for the PCB in the present invention may further include (e) a curing accelerator. The curing accelerator may include an organic metal salt or an organometallic complex, which includes at least one metal selected from the group including iron, copper, zinc, cobalt, lead, nickel, manganese, and tin.

Examples of the organic metal salt or the organometallic complex include, but are not limited to, iron naphthenates, copper naphthenates, zinc naphthenates, cobalt naphthenates, nickel naphthenates, manganese naphthenates, tin naphthenates, zinc octanoate, tin octanoate, iron octanoate, copper octanoate, zinc 2-ethylhexanate, lead acetylacetonate, cobalt acetylacetonate, or dibutyltin maleate. Also, the materials may be used alone or in combination.

Also, the curing accelerator is preferably included in an amount of 0.0001 to 0.1 parts by weight, based on 10 to 60 parts by weight of polyphenylene ether. If the curing accelerator is included in an amount of less than 0.0001 parts by weight, curing may not be carried out or requires high temperature or a long time. On the other hand, if the curing accelerator is included in an amount of greater than 0.1 parts by weight, a problem may occur in the storage stability of a resin composition, or the properties of a cured resin may be deteriorated.

The resin composition for the PCB in the present invention may further include an additive, such as inorganic filler, besides the above mentioned components. Examples of the inorganic filler may include silica, alumina, aluminum hydroxide, calcium carbonate, clay, talc, silicon nitride, boron nitride, titanium oxide, barium titanate, or titanate, etc. However, the present invention is not limited thereto.

The resin composition for the PCB in the present invention may be prepared by uniformly mixing a modified polyphenylene ether resin, a polymer binder, and cyanate ester or the prepolymer of the cyanate ester (optionally, a flame retardant, and an additional additive).

Meanwhile, a composite substrate of the present invention is fabricated by coating or impregnating the substrate with the PCB resin composition according to the present invention, followed by drying. Preferably, the composite substrate is for a PCB.

Herein, the drying may be carried out within a range of 20˜200° C., but the present invention is not limited thereto.

The substrate is at least one selected from the group including glass fabric, glass fiber non-woven fabric, polyamide fabric, polyamide fiber non-woven fabric, polyester fabric, and polyester fiber non-woven fabric. Herein, the composite substrate is preferably a prepreg for a PCB.

Also, the substrate may be at least one selected from the group including a glass plate, a polymer film, and a metal plate, but the present invention is not limited thereto. Also, as the polymer film and the metal plate, a film including a conventional polymer known in the art, and a plate including a conventional metal or alloy known in the art may be used, respectively, with no particular limitation. Herein, when the metal plate is a copper foil, a composite substrate formed by coating the resin composition according to the present invention on the copper foil, followed by drying, may be used as a copper laminate.

The coating may be carried out by using a conventional coating method known in the art, and non-limiting examples of the coating method may include lip coating, die coating, roll coating, comma coating, or a mixed method thereof.

Also, the composite substrate of the present invention may be fabricated by laminating at least two composite substrates, in which each substrate is coated or impregnated with the resin composition according to the present invention, followed by drying.

In the present invention, a copper laminate is formed by laminating the composite substrate and copper foil according to the present invention and subjecting the laminated materials to a heat/pressure forming treatment. Herein, the composite substrate is preferably a prepreg. Also, in forming the laminate, the heating/pressuring conditions may be appropriately adjusted according to the thickness of a fabricated laminate, the kind of the resin composition according to the present invention, etc.

Reference will now be made in detail to the preferred embodiments of the present invention. However, the following examples are illustrative only, and the scope of the present invention is not limited thereto.

### EXAMPLE 1

(Preparation of a Resin Composition)

As noted in Table 1, 30 parts by weight of polyphenylene ether (Nornyl PX9701, available from GE) having a number-average molecular weight of 2,000 to 20,000, 0.3 parts by weight of 9,9-bis(3-methyl-4-hydroxyphenyl)fluorene (BCF), 0.27 parts by weight of t-butylperoxy isopropylmonocarbonate (PB-I, available from Nippon Oil & Fats) as a radical initiator, and 0.008 parts by weight of cobalt naphthanate having a cobalt content of 6% as a catalyst were mixed, and were subjected to a reaction at 90° C. for 60 minutes to provide a polyphenylene ether resin modified to have a number-average molecular weight of 12,500.

To the modified polyphenylene ether resin, 10 parts by weight of a styrene-butadiene block copolymer (Tufprene A, available from Asahi Kasei) as a polymer binder, 50 parts by weight of cyanate ester (PT-15, available from Lonza), 10 parts by weight of brominated organic flame retardant (Planelon BDE, available from Mitsui Toatsu Fine chemical), and 0.0001 parts by weight of zinc octanoate (available from Western reserve chemical) having a zinc content of 12 to 13% as a curing accelerator were added, followed by stirring for about 1 hour to prepare a resin composition.

(Fabrication of a Composite Substrate)

The prepared resin composition was coated on a copper foil by a comma coating, followed by drying at 180° C. to obtain a composite substrate including a resin film formed on the copper foil thereof.

### EXAMPLE 2

A resin composition and a composite substrate were obtained in the same manner as described in Example 1, except that a styrene-butadiene block copolymer, cyanate ester, and a flame retardant were used in an amount of 5 parts by weight, 60 parts by weight, and 5 parts by weight, respectively, as noted in Table 1.

### EXAMPLE 3

A resin composition and a composite substrate were obtained in the same manner as described in Example 1, except that benzoyl peroxide was used as a radical initiator, instead of t-butylperoxy isopropylmonocarbonate (PB-I, available from Nippon Oil & Fats) as noted in Table 1.

### EXAMPLE 4

A resin composition and a composite substrate were obtained in the same manner as described in Example 1, except that benzoyl peroxide was used as a radical initiator, instead of t-butylperoxy isopropylmonocarbonate (PB-I, available from Nippon Oil & Fats), and a styrene-butadiene block copolymer, cyanate ester, and a flame retardant were used in an amount of 5 parts by weight, 60 parts by weight, and 5 parts by weight, respectively, as noted in Table 1.

### COMPARATIVE EXAMPLE 1

A resin composition and a composite substrate were obtained in the same manner as described in Example 1, except that bisphenol A was used, instead of 9,9-bis(3-methyl-4-hydroxyphenyl)fluorene as noted in Table 1.

### COMPARATIVE EXAMPLE 2

A resin composition and a composite substrate were obtained in the same manner as described in Example 4, except that bisphenol A was used, instead of 9,9-bis(3-methyl-4-hydroxyphenyl)fluorene as noted in Table 1.

TABLE 1

| | Example | | | | Comp. Exp. | |
|---|---|---|---|---|---|---|
| Components | 1 | 2 | 3 | 4 | 1 | 2 |
| Polyphenylene ether | 30 | 30 | 30 | 30 | 30 | 30 |
| (PPE) | | | | | | |
| Bisphenol A | — | — | — | — | 0.3 | 0.3 |
| 9,9-bis(3-methyl-4- | 0.3 | 0.3 | 0.3 | 0.3 | — | — |
| hydroxyphenyl)fluorene | | | | | | |
| (BCF) | | | | | | |
| PB-I (radical | 0.27 | 0.27 | — | — | 0.27 | — |
| initiator) | | | | | | |
| benzoyl peroxide | — | — | 0.27 | 0.27 | — | 0.27 |
| (radical initiator) | | | | | | |
| cobalt naphthanate | 0.008 | 0.008 | 0.008 | 0.008 | 0.008 | 0.008 |
| (catalyst) | | | | | | |
| Molecular weight of | 12500 | 12500 | 6400 | 6400 | 11000 | 2800 |
| modified | | | | | | |
| polyphenylene ether | | | | | | |
| styrene-butadiene | 10 | 5 | 10 | 5 | 10 | 5 |
| block copolymer | | | | | | |
| Cyanate ester | 50 | 60 | 50 | 60 | 50 | 60 |
| Flame retardant | 10 | 5 | 10 | 5 | 10 | 5 |
| Zinc octanoate | 0.0001 | 0.0001 | 0.0001 | 0.0001 | 0.0001 | 0.0001 |

### EXPERIMENTAL EXAMPLE 1

The physical property of each of the composite substrates obtained from Examples 1 to 4 and Comparative Examples 1 and 2 was tested by the following method. The results are shown in the following Table 2.

(1) Glass transition temperature (T_{g}): The measurement was carried out by using DSC (Differential Scanning Calorimeter), after etching and removing a copper foil layer of a composite substrate.

(2) Permittivity: The measurement was carried out by using a Material Analyzer in accordance with IPC TM-650. 2.5.5.1.

(3) Heat resistance of lead: Samples cut into a size of 5 cm×5 cm were fed into a solder bath at 288° C., and a time when abnormality starts to occur was measured.

(4) Adhesive strength of a copper foil: The measurement was carried out in accordance with IPC-TM-650. 2.4.8.

(5) Flame retardancy: The measurement was carried out in accordance with UL 94.

TABLE 2

| | Example | | | | Comp. Exp. | |
|---|---|---|---|---|---|---|
| Items | 1 | 2 | 3 | 4 | 1 | 2 |
| Glass transition | 231 | 245 | 220 | 238 | 196 | 202 |
| temperature (Tg, ° C.) | | | | | | |
| Permittivity (R/C = 52% | 2.64/0.004 | 2.58/0.002 | 2.54/0.003 | 2.51/0.002 | 2.86/0.007 | 2.81/0.006 |
| at 1 MHz) & | | | | | | |
| Dissipation factor | | | | | | |
| (at 1 GHz) | | | | | | |
| Heat resistance of | 600 s | 600 s | 600 s | 600 s | 120 s | 180 s |
| lead (@288) | | | | | | |
| Adhesive strength of | 1.4 | 1.2 | 1.5 | 1.3 | 1.1 | 0.9 |
| a copper foil (kN/m) | | | | | | |
| Flame retardancy | V-0 | V-1 | V-0 | V-1 | V-0 | V-1 |

As noted in Table 2, as compared to Comparative Examples 1 and 2 in which a polyphenylene ether resin modified by a redistribution reaction of polyphenylene ether in the presence of conventional bisphenol A was used, Examples 1 to 4, in which a polyphenylene ether resin modified by a redistribution reaction of polyphenylene ether in the presence of 9,9-bis(3-methyl-4-hydroxyphenyl)fluorene was used, showed improved results in physical properties such as glass transition temperature, permittivity, heat resistance, adhesive strength, etc.

### EXAMPLE 5

(Preparation of a Resin Composition)

As noted in Table 3, 30 parts by weight of polyphenylene ether (Nornyl PX9701, available from GE) having a number-average molecular weight of 2,000 to 20,000, 2 parts by weight of 9,10-dihydro-9-oxa-10-(2,5-dihydroxyphenyl)-10-phosphaphenanthrene 10-oxide (HCA-HQ, available from Sanko), 0.9 parts by weight of t-butylperoxy isopropylmonocarbonate (PB-I, available from Nippon Oil & Fats) as a radical initiator, and 0.016 parts by weight of cobalt naphthanate having a cobalt content of 6% as a catalyst were mixed, and were subjected to a reaction at 90° C. for 60 minutes to provide a polyphenylene ether resin modified to have a number-average molecular weight of 5,800.

To the modified polyphenylene ether resin, 10 parts by weight of a styrene-butadiene block copolymer (Tufprene A, available from Asahi Kasei) as a polymer binder, 50 parts by weight of cyanate ester (PT-15, available from Lonza), and 0.0001 parts by weight of zinc octanoate (available from Western reserve chemical) having a zinc content of 12 to 13% as a curing accelerator were added, followed by stirring for about 1 hour to prepare a resin composition.

(Fabrication of a Composite Substrate)

The prepared resin composition was coated on a copper foil by a comma coating, followed by drying at 180° C. to obtain a composite substrate including a resin film formed on the copper foil thereof.

### EXAMPLE 6

A resin composition and a composite substrate were obtained in the same manner as described in Example 5, except that cyanate ester was used in an amount of 60 parts by weight as noted in Table 3.

### EXAMPLE 7

A resin composition and a composite substrate were obtained in the same manner as described in Example 5, except that benzoyl peroxide was used as a radical initiator, instead of t-butylperoxy isopropylmonocarbonate (PB-I, available from Nippon Oil & Fats) as noted in Table 3.

### EXAMPLE 8

A resin composition and a composite substrate were obtained in the same manner as described in Example 5, except that benzoyl peroxide was used as a radical initiator, instead of t-butylperoxy isopropylmonocarbonate (PB-I, available from Nippon Oil & Fats), and cyanate ester was used in an amount of 60 parts by weight, as noted in Table 3.

### COMPARATIVE EXAMPLE 3

A resin composition and a composite substrate were obtained in the same manner as described in Example 5, except that 0.3 parts by weight of bisphenol A, instead of 9,10-dihydro-9-oxa-10-(2,5-dihydroxyphenyl)-10-phosphaphenanthrene 10-oxide, was used, 0.27 parts by weight of t-butylperoxy isopropylmonocarbonate (PB-I, available from Nippon Oil & Fats) was used as a radical initiator, and 0.008 parts by weight of cobalt naphthanate having a cobalt content of 6% was used as a catalyst, as noted in Table 3.

### COMPARATIVE EXAMPLE 4

A resin composition and a composite substrate were obtained in the same manner as described in Example 8, except that 0.3 parts by weight of bisphenol A, instead of 9,10-dihydro-9-oxa-10-(2,5-dihydroxyphenyl)-10-phosphaphenanthrene 10-oxide, was used, 0.27 parts by weight of benzoyl peroxide, instead of t-butylperoxy isopropylmonocarbonate (PB-I, available from Nippon Oil & Fats), was used as a radical initiator, and 0.008 parts by weight of cobalt naphthanate having a cobalt content of 6% was used as a catalyst, as noted in Table 3.

TABLE 3

| | |
|---|---|
| Example | Comp. Exp. |

| Components | 5 | 6 | 7 | 8 | 3 | 4 |
|---|---|---|---|---|---|---|
| Polyphenylene ether | 30 | 30 | 30 | 30 | 0 | 30 |
| (PPE) | | | | | | |
| Bisphenol A | — | — | — | — | 0.3 | 0.3 |
| 9,10-dihydro-9-oxa- | 2 | 2 | 2 | 2 | — | — |
| 10-(2,5- | | | | | | |
| dihydroxyphenyl)-10- | | | | | | |
| phosphaphenanthrene | | | | | | |
| 10-oxide (HCA-HQ) | | | | | | |
| PB-I (radical | 0.9 | 0.9 | — | — | 0.27 | — |
| initiator) | | | | | | |
| benzoyl peroxide | — | — | 0.9 | 0.9 | — | 0.27 |
| (radical initiator) | | | | | | |
| cobalt naphthanate | 0.016 | 0.016 | 0.016 | 0.016 | 0.008 | 0.008 |
| (catalyst) | | | | | | |
| Molecular weight of | 5800 | 5800 | 3100 | 3100 | 11000 | 2800 |
| modified | | | | | | |
| polyphenylene ether | | | | | | |
| styrene-butadiene | 10 | 10 | 10 | 10 | 10 | 10 |
| block copolymer | | | | | | |
| Cyanate ester | 50 | 60 | 50 | 60 | 50 | 60 |
| Flame retardant | — | — | — | — | — | — |
| Zinc octanoate | 0.0001 | 0.0001 | 0.0001 | 0.0001 | 0.0001 | 0.0001 |

### EXPERIMENTAL EXAMPLE 2

The physical property of each of the composite substrates obtained from Examples 5 to 8 and Comparative Examples 3 and 4 was tested in the same manner as described in Experimental Example 1. The results are shown in the following Table 4.

TABLE 4

| | Example | | | | Comp. Exp. | |
|---|---|---|---|---|---|---|
| Items | 5 | 6 | 7 | 8 | 3 | 4 |
| Glass transition | 241 | 250 | 249 | 256 | 199 | 208 |
| temperature (Tg, ° C.) | | | | | | |
| Permittivity (R/C = 52% | 2.55/0.004 | 2.46/0.002 | 2.49/0.003 | 2.40/0.002 | 2.89/0.007 | 2.80/0.006 |
| at 1 MHz) & | | | | | | |
| Dissipation factor (at | | | | | | |
| 1 GHz) | | | | | | |
| Heat resistance of lead | 600 s | 600 s | 600 s | 600 s | 120 s | 180 s |
| (@288) | | | | | | |
| Adhesive strength of a | 1.3 | 1.1 | 1.4 | 1.2 | 1.1 | 0.9 |
| copper foil (kN/m) | | | | | | |
| Flame retardancy | V-0 | V-0 | V-0 | V-0 | V-1 | V-1 |

As noted in Table 4, as compared to Comparative Examples 3 and 4, in which a polyphenylene ether resin modified by a redistribution reaction of polyphenylene ether in the presence of conventional bisphenol A was used, Examples 5 to 8, in which a polyphenylene ether resin modified by a redistribution reaction of polyphenylene ether in the presence of 9,10-dihydro-9-oxa-10-(2,5-dihydroxyphenyl)-10-phosphaphenanthrene 10-oxide was used, showed improved results in physical properties such as glass transition temperature, permittivity, heat resistance, adhesive strength, flame retardancy, etc.

### INDUSTRIAL APPLICABILITY

In the present invention, instead of a conventionally used bisphenol A, 9,9-bis(hydroxyaryl)fluorene or 9,10-dihydro-9-oxa-10-(dihydroxyaryl)-10-phosphaphenanthrene 10-oxide is used to carry out a redistribution reaction of polyphenylene ether. Also, when a resin composition including a polyphenylene ether resin modified by such a redistribution reaction is used, it is possible to fabricate a copper laminate having low permittivity appropriate for high speed and high frequency of a signal, as well as a relatively high glass transition temperature, high heat resistance, high adhesive strength and high flame retardancy.

Although several exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A resin composition for a PCB, the composition comprising:
(a) a polyphenylene ether resin modified via a redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide;
(b) a polymer binder; and
(c) cyanate ester or a prepolymer of the cyanate ester,
wherein, when the polyphenylene ether resin is modified via a redistribution reaction of the polyphenylene ether in the presence of 9,9-bis(hydroxyaryl)fluorene, the composition further comprises (d) a flame retardant.

2. The resin composition as claimed in claim 1, which comprises 10 to 60 parts by weight of polyphenylene ether; 0.1 to 5 parts by weight of 9,9-bis(hydroxyaryl)fluorene or 9,10-dihydro-9-oxa-10-(dihydroxyaryl)-10-phosphaphenanthrene 10-oxide; 5 to 40 parts by weight of polymer binder; and 10 to 60 parts by weight of cyanate ester or prepolymer of the cyanate ester,
wherein, when the flame retardant is further included, the flame retardant is included in an amount of 5 to 40 parts by weight.

3. The resin composition as claimed in claim 1, wherein the 9,9-bis(hydroxyaryl)fluorene is at least one compound selected from the group including compounds represented by following Formula 1 to Formula 3: 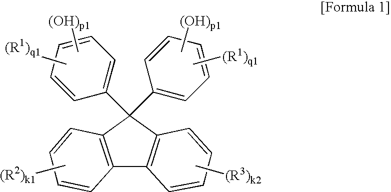
wherein each of R¹ to R³ independently represents a C₁˜C₆ alkyl group, p1 is an integer ranging from 1 to 5, q1 is an integer ranging from 0 to 4, p1+q1 is an integer equal to or less than 5, and each of k1 and k2 is independently an integer ranging from 0 to 4; 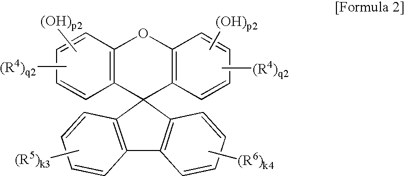
wherein each of R⁴ to R⁶ independently represents a C₁˜C₆ alkyl group; p2 is an integer ranging from 1 to 4, q2 is an integer ranging from 0 to 3, p2+q2 is an integer equal to or less than 4; each of k3 and k4 is independently an integer ranging from 0 to 4; and 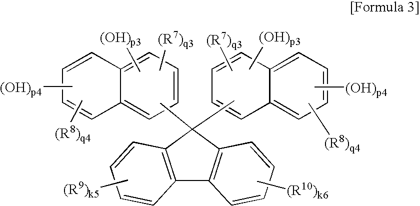
wherein each of R⁷ to R¹⁰ independently represents a C₁˜C₆ alkyl group, p3 is an integer ranging from 1 to 3, p4 is an integer ranging from 0 to 4, each of q3 and q4 is independently an integer ranging from 0 to 2, p3+q3 is an integer equal to or less than 3, p4+q4 is an integer equal to or less than 4, and each of k5 and k6 is independently an integer ranging from 0 to 4.

4. The resin composition as claimed in claim 1, wherein the 9,10-dihydro-9-oxa-10-(dihydroxyaryl)-10-phosphaphenanthrene 10-oxide is at least one compound selected from the group including compounds represented by following Formula 4 and Formula 5: 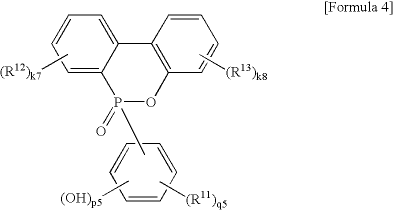
wherein each of R¹¹ to R¹³ independently represents a C₁˜C₆ alkyl group, p5 is 2, q5 is an integer ranging from 0 to 3, and each of k7 and k8 is independently an integer ranging from 0 to 4; and 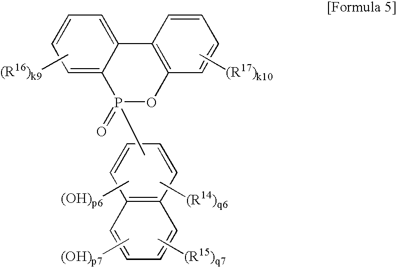
wherein each of R¹⁴ to R¹⁷ independently represents a C₁˜C₆ alkyl group, each of p6 and p7 is independently an integer ranging from 0 to 2, p6+p7 is 2, p6+q6 is an integer equal to or less than 3, p7+q7 is an integer equal to or less than 4, and each of k9 and k10 is independently an integer ranging from 0 to 4.

5. The resin composition as claimed in claim 1, wherein the redistribution reaction is carried out in the presence of a radical initiator and/or a catalyst.

6. The resin composition as claimed in claim 1, wherein (b) the polymer binder is at least one selected from the group including polyvinyl acetate, phenoxy resin, a styrene-butadiene block copolymer, a poly(styrene-butadiene-methyl methacrylate) block copolymer, and poly (methyl methacrylate-butyl acrylate-methyl methacrylate)block copolymer.

7. The resin composition as claimed in claim 1, wherein (c) the cyanate ester has at least two cyanate groups in a molecule.

8. The resin composition as claimed in claim 1, wherein (c) the cyanate ester is at least one compound selected from the group including compounds represented by following Formula 6 and Formula 7: 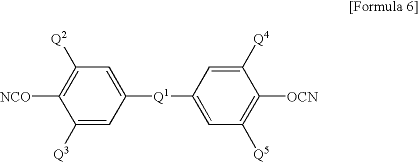
wherein Q¹ represents 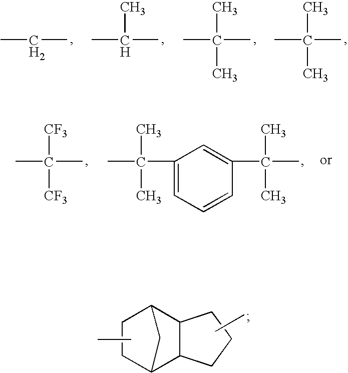
and each of Q² to Q⁵ independently represents hydrogen or a C₁˜C₆ alkyl group; and 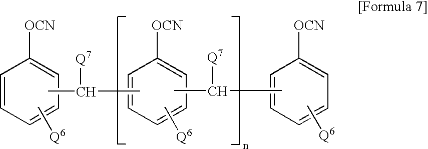
wherein each of Q⁶ and Q⁷ independently represents hydrogen or a C₁˜C₆ alkyl group, and n is an integer equal to or more than 0.

9. The resin composition as claimed in claim 1, wherein (d) the flame retardant is at least one selected from the group including 1,2-dibromo-4-(1,2-dibromoethyl)cyclohexane, tetrabromocyclohexane, tetrabromocyclooctane, hexabromocyclodecane, hexabromocyclododecane, 2,4,6-tris(tribromophenoxy)-1,3,5-triazine, bis(tribromophenoxy)ethane, brominated polyphenylene ether and brominated polystyrene.

10. The resin composition as claimed in claim 1, further comprising (e) a curing accelerator.

11. The resin composition as claimed in claim 10, wherein (e) the curing accelerator comprises an organic metal salt or an organometallic complex, the organic metal salt or the organometallic complex comprising at least one metal selected from the group including iron, copper, zinc, cobalt, lead, nickel, manganese, and tin.

12. A composite substrate formed by coating or impregnating a substrate with a resin composition for a PCB, followed by drying, the resin composition for the PCB comprising:
(a) a polyphenylene ether resin modified via a redistribution reaction of polyphenylene ether in the presence of 9,9-bis(hydroxyaryl)fluorene or 9,10-dihydro-9-oxa-10-(dihydroxyaryl)-10-phosphaphenanthrene 10-oxide;
(b) a polymer binder; and
(c) cyanate ester or a prepolymer of the cyanate ester,
wherein, when the polyphenylene ether resin is modified via a redistribution reaction of polyphenylene ether in the presence of 9,9-bis(hydroxyaryl)fluorene, the composition further comprises (d) a flame retardant.

13. The composite substrate as claimed in claim 12, wherein the substrate is at least one selected from the group including glass fabric, glass fiber non-woven fabric, polyamide fabric, polyamide fiber non-woven fabric, polyester fabric, and polyester fiber non-woven fabric, and the composite substrate is a prepreg for the PCB.

14. The composite substrate as claimed in claim 12, wherein the substrate is at least one selected from the group including a glass plate, a polymer film, and a metal plate.

15. The composite substrate as claimed in claim 12, which comprises 10 to 60 parts by weight of polyphenylene ether, 0.1 to 5 parts by weight of 9,9-bis(hydroxyaryl)fluorene or 9,10-dihydro-9-oxa-10-(dihydroxyaryl)-10-phosphaphenanthrene 10-oxide, 5 to 40 parts by weight of polymer binder, and 10 to 60 parts by weight of cyanate ester or 10 to 60 parts by weight of prepolymer of the cyanate ester,
wherein, when the flame retardant is further included, the flame retardant is included in an amount of 5 to 40 parts by weight.

16. The composite substrate as claimed in claim 12, wherein the 9,9-bis(hydroxyaryl)fluorene is at least one compound selected from the group including compounds represented by following Formula 1 to Formula 3: 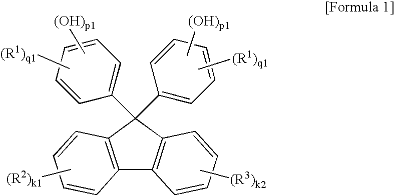
wherein each of R¹ to R³ independently represents a C₁˜C₆ alkyl group, p1 is an integer ranging from 1 to 5, q1 is an integer ranging from 0 to 4, p1+q1 is an integer equal to or less than 5, and each of k1 and k2 is independently an integer ranging from 0 to 4; 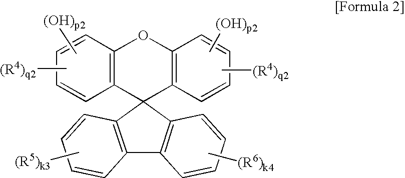
wherein each of R⁴ to R⁶ independently represents a C₁˜C₆ alkyl group, p2 is an integer ranging from 1 to 4, q2 is an integer ranging from 0 to 3, p2+q2 is an integer equal to or less than 4, and each of k3 and k4 is independently an integer ranging from 0 to 4; and 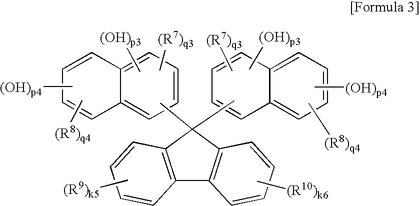
wherein each of R⁷ to R¹⁰ independently represents a C₁˜C₆ alkyl group, p3 is an integer ranging from 1 to 3, p4 is an integer ranging from 0 to 4, each of q3 and q4 is independently an integer ranging from 0 to 2, p3+q3 is an integer equal to or less than 3, p4+q4 is an integer equal to or less than 4, and each of k5 and k6 is independently an integer ranging from 0 to 4.

17. The composite substrate as claimed in claim 12, wherein the 9,10-dihydro-9-oxa-10-(dihydroxyaryl)-10-phosphaphenanthrene 10-oxide is at least one compound selected from the group including compounds represented by following Formula 4 and Formula 5: 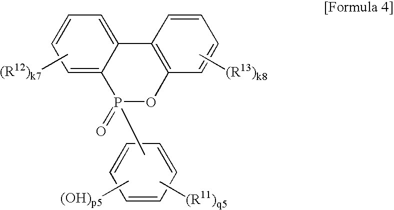
wherein each of R¹¹ to R¹³ independently represents a C₁˜C₆ alkyl group, p5 is 2, q5 is an integer ranging from 0 to 3, and each of k7 and k8 is independently an integer ranging from 0 to 4; and 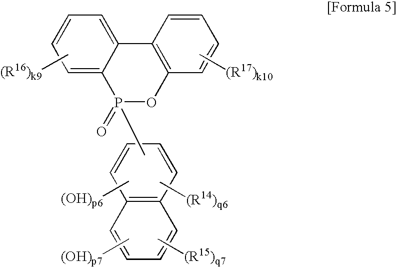
wherein each of R¹⁴ to R¹⁷ independently represents a C₁˜C₆ alkyl group, each of p6 and p7 is independently an integer ranging from 0 to 2, p6+p7 is 2, p6+q6 is an integer equal to or less than 3, p7+q7 is an integer equal to or less than 4, and each of k9 and k10 is independently an integer ranging from 0 to 4.

18. The composite substrate as claimed in claim 12, wherein the redistribution reaction is carried out in the presence of a radical initiator and/or a catalyst.

19. The composite substrate as claimed in claim 12, wherein (b) the polymer binder is at least one selected from the group including polyvinyl acetate, phenoxy resin, a styrene-butadiene block copolymer, a poly(styrene-butadiene-methyl methacrylate) block copolymer, and poly (methyl methacrylate-butyl acrylate-methyl methacrylate)block copolymer.

20. The composite substrate as claimed in claim 12, wherein (c) the cyanate ester has at least two cyanate groups in a molecule.

21. The composite substrate as claimed in claim 12, wherein (c) the cyanate ester is at least one compound selected from the group including compounds represented by following Formula 6 and Formula 7: 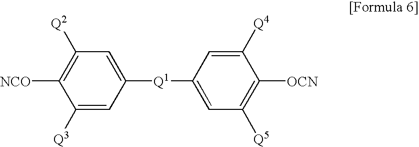
wherein Q¹ represents 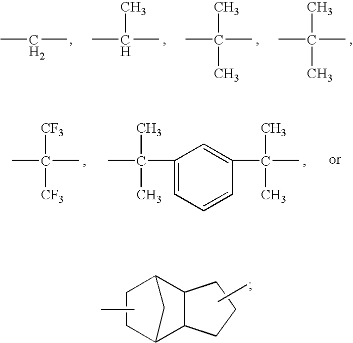
and each of Q² to Q⁵ independently represents hydrogen or a C₁˜C₆ alkyl group; and 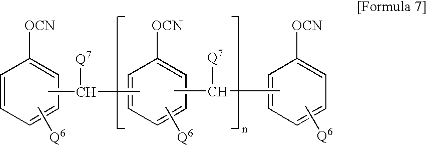
wherein each of Q⁶ and Q⁷ independently represents hydrogen or a C₁˜C₆ alkyl group, and n is an integer equal to or more than 0.

22. The composite substrate as claimed in claim 12, wherein (d) the flame retardant is at least one selected from the group including 1,2-dibromo-4-(1,2-dibromoethyl)cyclohexane, tetrabromocyclohexane, tetrabromocyclooctane, hexabromocyclodecane, hexabromocyclododecane, 2,4,6-tris(tribromophenoxy)-1,3,5-triazine, bis(tribromophenoxy)ethane, brominated polyphenylene ether and brominated polystyrene.

23. The composite substrate as claimed in claim 12, further comprising (e) a curing accelerator.

24. A copper laminate formed by laminating the composite substrate as claimed in claim 12 and a copper foil, followed by heat/pressure forming.
